(19) United States
(12) Patent Application Publication
(10) Pub. No.: US 2009/0244266 A1
(43) Pub. Date: Oct. 1, 2009

(54) Enhanced Three Dimensional Television

(76) Inventor: Thomas Carl Brigham, New York, NY (US)

Correspondence Address: Thomas C. Brigham, 72 Warren St., New York, NY, 10007, US

(21) Appl. No.: 12/056,266

(22) Filed: Mar. 26, 2008

(51) Int. Cl. H04N 13/04

(52) U.S. Cl. 348/51; 348/E13.001

(57) ABSTRACT

The performance of autoscopic multiview displays such as glasses free three dimensional television is improved by the application of adaptive crosstalk cancelation information. Adaptive crosstalk cancelation information is created using a display profile for a three dimensional television and is applied to imagery displayed on the three dimensional television thereby reducing the presence of crosstalk and ghosting that otherwise degrades the quality of imagery displayed. Adaptive crosstalk cancellation information is also applied to improve the quality of lenticular hardcopy imagery and illuminated barrier strip three dimensional signage.

### BACKGROUND

1. Field of the Invention

The present invention relates to a method for displaying sets of imagery comprised of three or more views that are displayed by autoscopic multiview displays such as three dimensional television, lenticular hardcopy, and barrier strip illuminated signage.

2. Description of Prior Art

Three dimensional television holds public interest and fascination due to its novel and vivid content. Stereoscopic three dimensional movies are currently experiencing a surge of interest, however the need for special glasses that are required to view them presents an obstacle to the wider adoption of this kind of three dimensional content.

There is an unmet need for entertainment that affords the enjoyment of three dimensional content without the imposition of special viewing devices required to experience the content. Prior to the advances achieved by the present invention all existing systems for displaying three dimensional content share a disadvantage of failing to achieve three dimensional effects comparable to those produced by stereoscopic systems that use special 3D glasses.

Display systems that are free of special 3D glasses incorporate means for directing each of multiple views comprising the content separately to the left eye or the right eye of the viewer. This is achieved by limiting the spatial extent of the visibility of the component imagery to particular observational positions such that one part of the dimensional imagery displayed is seen from the position of the viewer's left eye and another part of the dimensional imagery is seen from the position of the viewer's right eye.

Imperfections in the available systems for achieving this separation of component imagery result in views of the desired portions of image content that are not completely isolated from undesired portions of image content.

Stereopticon viewers achieve total isolation of the views delivered to the left and right eyes while liquid crystal shutters and polarized 3D glasses, that are both used to project stereo motion pictures in theatrical venues, while generally superior the crosstalk ghosting seen in autoscopic multiview displays, do not achieve total isolation. A number of inventions have been developed to address this problem with stereoscopic projection.

In U.S. Pat. No. 6,532,008 Guralnick et al disclose a method and apparatus for eliminating stereoscopic cross images. By this method the compensation is achieved by adding an inversion of the impinging imagery from the right eye to the left eye prior to display so that the effect of the impinging imagery is subtracted out. The information that describes the values used to perform this are the result of a process of interactive discovery involving the repeated increasing and decreasing of parameters while 3D viewing is enabled and the relative presence and absence of crosstalk is observed.

This method will prove impractical should an effort be made to apply it in an analogous manner to an autoscopic multiview display having three or more image components, such as a three dimensional television. When modifications are made to the parameter for the second image component and an optimal value is arrived upon, proceeding to the third image component and modifying that parameter for the third image component will change the display such that the previously selected value for the second image component is no longer optimal. Finding the optimal values for each of a multitude of component images exhibiting separate and distinct crosstalk influences would require undue experimentation and the optimum values cannot be arrived at in a predictable and practical manner.

In EP0 953 962A2 Graham Jones discloses a display controller for three dimensional display. That disclosure includes a method of reducing crosstalk between first and second images by producing respective sets of crosstalk corrected images by subtracting from the first image an amount equal to a given fraction of the second image and subtracting from the second image an amount equal to the given fraction of the first image. There exists no obvious extension of this technique to the case of more than two images because a single given fraction applied to all of the multiple image elements will not yield optimal results and provision is not made for multiple fractions to be applied variously among multiple images. Furthermore it will be shown that according to the limitation by Jones to the operation of subtraction only it is impossible to achieve an optimal cancelation such as is achieved by applying the adaptive crosstalk cancelation information introduced in the present invention. As will be shown below some terms for the fractions used to scale the neighboring images that contribute crosstalk artifacts and which are applied to create a crosstalk corrected image will produce optimum results only when the image components are applied in non negative proportions. Adaptive crosstalk cancelation information that dictates the addition of some unwanted material instead of just the subtraction of the unwanted material while achieving better results than can be achieved using only subtraction clearly shows the insufficiency of the methods disclosed by Jones as compared to the application of adaptive crosstalk cancelation information shown for the first time in the present invention.

In the Eurographics Symposium on Rendering (2006) edited by Tomas Akenine-Möller and Wolfgang Heidrich, Zwicker et el publish a paper titled Antialiasing for Automultiscopic 3D Displays. The authors acknowledge the problem of crosstalk in autoscopic multiview displays having more than three frames in section 5.2, under the heading: Controlling Scene Depth of Field. The authors suggest that “in a practical scenario, a user wants to ensure that a given depth range in the scene is mapped to the depth of field of the display and appears sharp.” In FIG. 9 a simulated display of a three dimensional image as it would appear on an autoscopic multiview display includes the undesirable blurring caused by crosstalk artifacts. As a solution to this problem the authors propose artificially reducing the amount of depth present in the image content. The authors are members of research programs at: the Department of Computer Science and Engineering, University of California, San, Diego; Mitsubishi Electric Research Laboratories; the Artificial Intelligence Laboratory, Massachusetts Institute of Technology. These research facilities are performing advanced work at the forefront of the field of three dimensional television and autoscopic multiview displays. That such practitioners would be unfamiliar with the advantages of adaptive crosstalk cancelation information and its application in solving these crosstalk artifact problem, without reducing the depth of the images, speaks to the non obvious nature of the present invention.

All prior proposals known to this inventor suffer from the following limiting factors: 1) inability to operate on autoscopic multiview displays comprised of three or more component images; 2) inability to arrive at the required values for multiple fractions without undue experimentation; 2) the lack of adaptive crosstalk cancelation information that is needed to achieve optimal crosstalk correction.

### OBJECTS AND ADVANTAGES

a) To improve three dimensional televisions by partially eliminating undesirable artifacts that occur in three dimensional televisions as they are currently made and operated.
b) To improve lenticular hardcopy by partially eliminating undesirable artifacts that occur in lenticular hardcopy as it is currently made.
c) To improve multiview barrier strip hardcopy by partially eliminating undesirable artifacts that occur in multiview barrier strip hardcopy as it is currently made.

Still further objects and advantages will become apparent from a consideration of the ensuing figures and descriptions.

### DESCRIPTION OF THE DRAWINGS

FIG. 1 is a flow chart of the method used to display a set of images on an autoscopic multiview display according to the prior art;

FIGS. 2A, 2B illustrate the ideal and real world performances of autoscopic multiview displays;

FIGS. 3a, 3b, 3c, 3d, 3e, 3f, 3g, 3h, 3i, illustrate a set of calibration images for an autoscopic multiview display according to the preferred embodiment of the present invention;

FIG. 4 illustrates a camera recording the calibration images presented on an autoscopic multiview display according to the preferred embodiment of the present invention;

FIG. 5 illustrates the result of viewing the calibration images on an autoscopic multiview display;

FIGS. 6a, 6b, 6c, 6d show numerical data comprising the input and output of the fit grading process used in the preferred embodiment of the present invention;

FIG. 7 shows tabulated values for the crosstalk contributions to an observed display;

FIGS. 8a, 8b, 8c (prior art) show a method of crosstalk cancellation for stereoscopic image pairs known in the prior art;

FIG. 9 shows a tabulated data matrix for computing a crosstalk compensated image by artifact negation;

FIG. 10 shows a tabulated data matrix for the simulation of an autoscopic multiview display presenting content compensated according to FIG. 9;

FIG. 11 shows the data for and results of computing a fit grade for the attempted correction shown in FIG. 10;

FIG. 12 shows the arrangement of variables in a crosstalk simulation matrix;

FIG. 13 is a listing of pseudo code that adapts the fractional values of the adaptive crosstalk cancellation information

FIG. 14 shows the results of simulating the application of first order adaptive crosstalk cancellation information

FIG. 15 shows the data for and results of computing a fit grade for the correction shown in FIG. 14;

FIG. 16 shows the results of simulating the application of higher order adaptive crosstalk cancellation information

FIG. 17 shows the data for and results of computing a fit grade for the correction shown in FIG. 16;

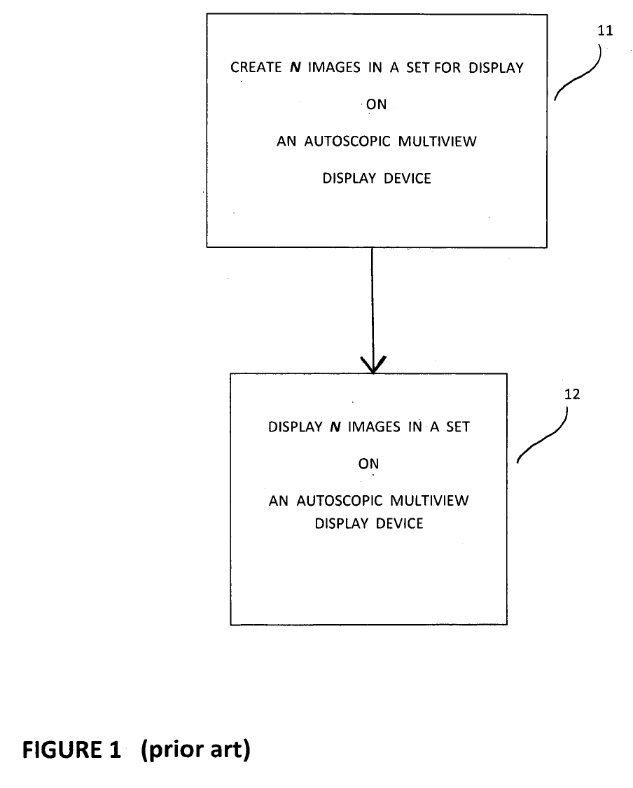

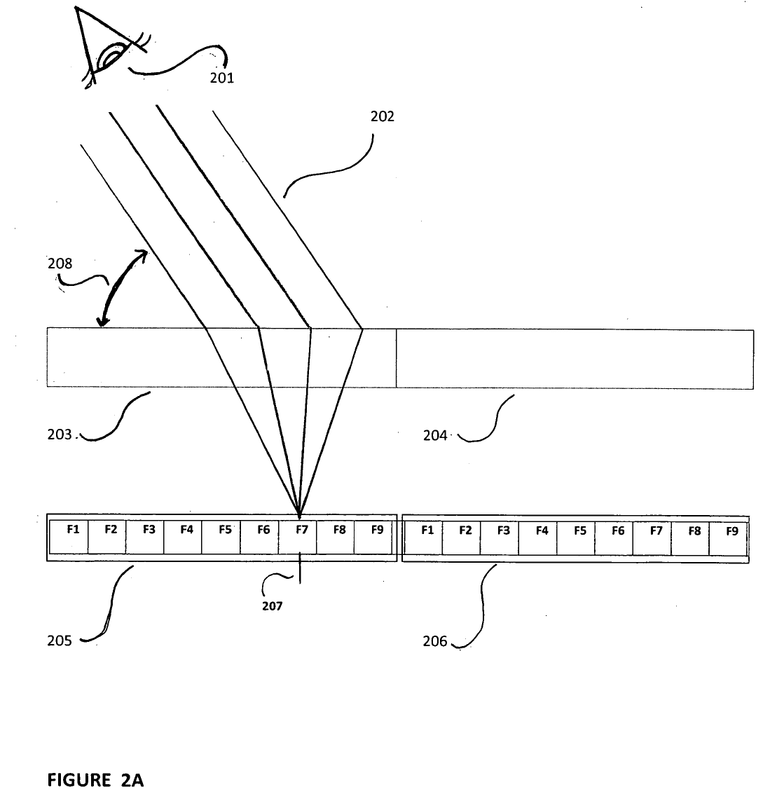

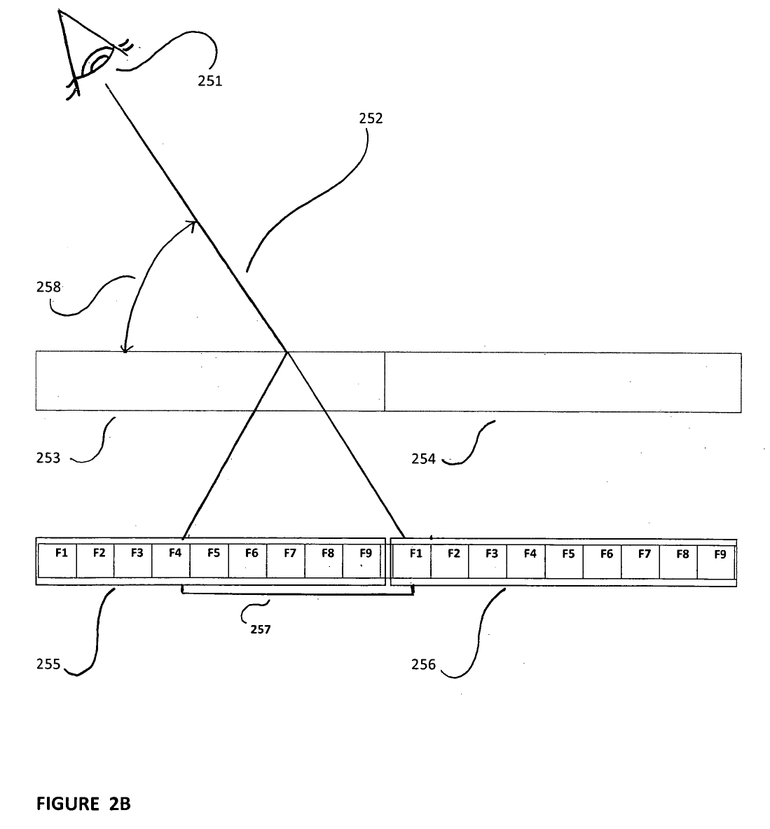

Referring to FIG. 1, there is shown a simple flow chart of the method used by the prior art systems to operate autoscopic multiview displays. A set of related source images 11 is created for simultaneous display by the autoscopic multiview display 12. The set of images 11 is loaded into the image storage facility of the display 12 where the viewing arrangement is multiplexed such that one image within the set of images is made to predominate the appearance of the display when seen from a particular viewing location. Accordingly the predominate image changes and is selected in sequence from within the multiview image set as the observer's position of observation changes along a path in space relative to the autoscopic multiview display. Depending on the method of display the portions of the set of images isolated for selective viewing may be directed to the observational position by an array of lenses whose focal point changes with the orientation of the viewer. Referring to FIG. 2A there is shown the operation of an autoscopic multiview display whereby portions 205 and 206 of each image component in the multiview image set may be isolated and interleaved so that each of multiple lenses 203 and 204 presents an assigned portion of a source image selected from corresponding portions in each of the components of the multiview image set. The optical element 208 isolates the image portion 207. By another method image elements are selected for isolation by the parallax action of a transparent gap in an opaque barrier that allows the passage of light in a direction corresponding to the angle of view. These two well known methods have been referred to as lenticular and barrier strip respectively.

When methods such as these are employed by the display 12 the viewer enjoys images that are different for both the left eye position and the right eye position affording the possibility of the perception of stereoscopic volumetric experience. The viewer can also enjoy imagery that changes in an animated or sequential manner in response to the viewers motion relative to the display.

The diagram shown in FIG. 2A shows the ideal characteristics of one type of autoscopic multiview display. According to the theoretical performance of such a display a viewer assumes a viewing position 201 at which he receives an optical transfer along the associated viewing path 202 emanating from an optical multiplexer 203 consisting of a lens whose focal point coincides with a point 207 within the spatial extent of imagery 205 composed of portions of individual images from within the set of multiple images provided for simultaneous autoscopic display. In this illustration F1 through F9 mark portions of individual input images or frames arranged in a sequential array along the expected path of the focal point 207 as it moves according to changes in the position of the observational point 201 and the consequent changes in the viewing angle 208 of the observers gaze relative to the autoscopic display. Additional optical elements such as 204 perform likewise with respect to additional portions of image content 206 selected from corresponding locations within the multiple images comprising the set of images provided for simultaneous autoscopic multiview display.

Under ideal conditions the observer 201 will see on the display element 203 image content belonging exclusively to the image component F7 located at position 207 in the configuration of the display apparatus. FIG. 2B shows the actual performance of a typical autoscopic multiview display. From a specific observational position 251 with an associated viewing angle 258 the received optical transfer 252 emanating from the display element 253 does not select a single point from which to sample the sequential array 255 of image portions but rather the display element 253 accepts contributions from image portions spanning a range 257 of locations within the structured arrangement of the components of the image set provided for simultaneous viewing by an autoscopic multiview display. As a result of the presence of unwanted contributions made by adjacent images in the sequential image set, degradation of image quality and the undesired appearance of ghosting, smearing, and streaking are seen by an observer.

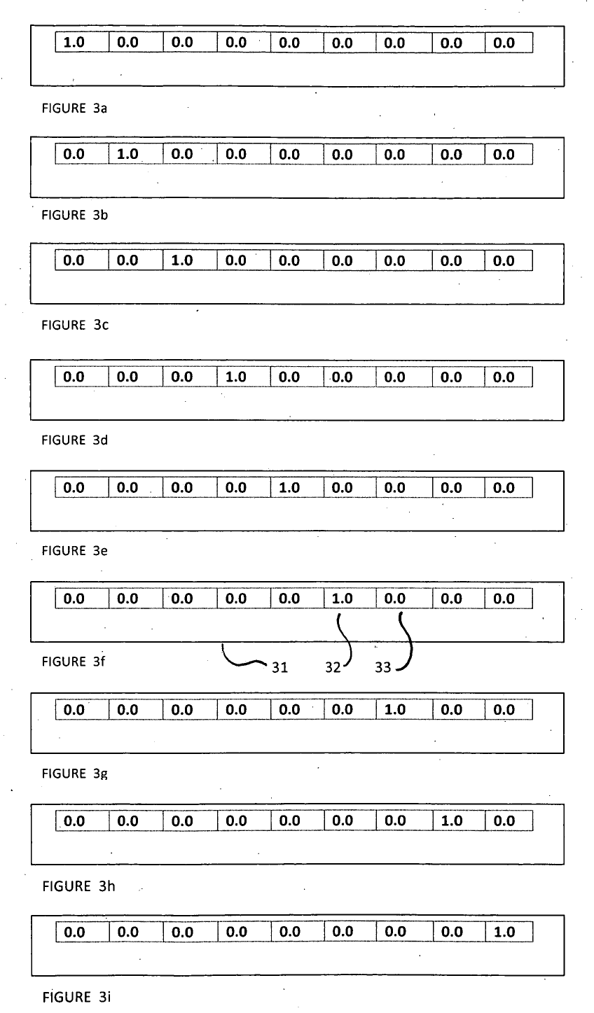

FIGS. 3a through 3i show a set of nine calibration images used to calculate the adaptive crosstalk compensation information in the preferred embodiment for the particular case where the multiview image sets to be displayed are comprised of a set of nine images for simultaneous presentation on an autoscopic multiview display. Each image in the set is composed of pictorial information depicting both a minimum and a maximum image value where black is the minimum and white is the maximum value.

Numerical values used in the preferred embodiment sometimes exceed the value of 1.00 or are less than 0.00, when these values are translated to the gamut of a display device they will be scaled and/or they will be clipped to fit the range of possible values according to preferences for the qualities of contrast and brightness in the display output.

These color values 32 and 33 are distributed within the plane of an image 31 such that a white value 32 is at position (x,y) in one image and a black value is at position (x,y) in all of the other images in the set. The color values extend as rectangular patches 32 and each image 31 in the set has unique locations wherein it contains white while all other images in the set contain black. In the preferred embodiment the images in the multiview calibration set, when displayed together by an autoscopic multiview display, depict a sequential animation of a white rectangle moving in a linear fashion such that through subsequent images the white rectangle appears to jump one adjacent position to the right as the constituent images of the set are multiplexed by the display. An observer moving his viewing position back and forth in front of the display can see the white square moving back and forth accompanying his changing position.

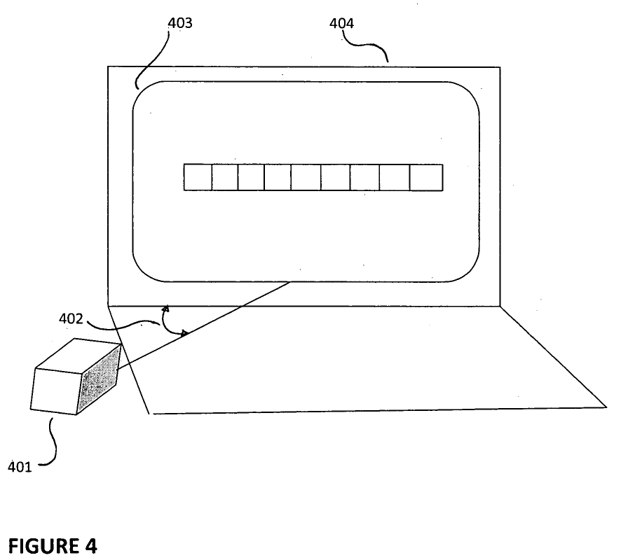

FIG. 4 shows a camera 401 recording the autoscopic multiview display 404 from a fixed position while the set of calibration images described by FIG. 3 are shown on the display screen 403.

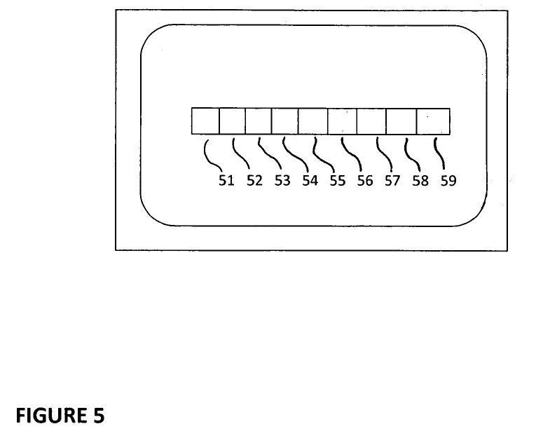

FIG. 5 shows a diagram depicting the image values received by the camera in the configuration shown in FIG. 4 while the autoscopic multiview apparatus displays the calibration image set described in FIG. 3. The patches of image content identified by 51 through 59 will transmit brightness values that depend on the angle of view 402 of the observer 401 relative to the display 404. The functional operation of the autoscopic multiview display causes the changing angle of view 402 to correspond to a unique offset into the set of images displayed.

As is seen in FIG. 2B this offset is subject to the diffusing properties of an associated range 257 where more than one of the images in the displayed image set contributes to some degree, normally one or two images will predominate relative to other members of the displayed image set. The calibration image set is designed to counteract the fact that when typical autoscopic multiview display content is viewed the presence and degree of contribution provided by individual members of the image set cannot easily be estimated accurately and the artifact is perceived is rather in degrees of image quality, and the appearance of streaking, and the loss of clarity.

As the calibration image set FIGS. 3a through 3i is simultaneously displayed and recorded from the position 401 each patch 51 through 59 shows a value directly proportional to the contribution made by the corresponding image components shown in FIG. 3A through FIG. 3F.

In the preferred embodiment the viewing position 401 is adjusted until a selected patch reaches its brightest value. From this view point the remaining values will typically have symmetrical values that diminish progressively moving in either direction adjacent to the brightest value. The observed color value of the image display corresponding to the patch with the brightest value is given a crosstalk coefficient of one and the other constituent image components of the displayed image set are given crosstalk coefficients in proportion to their observed values relative to brightest patch.

In the preferred embodiment the crosstalk coefficients are estimated to be symmetrical around the central value of the most evident image component as is typical of many displays. It is clear to the inventor that the present invention does not require this approximation that is performed to simplify calculations and data storage requirements. Likewise it is estimated that the crosstalk coefficients are uniform across the entire display while it is anticipated that the operation of this invention can be carried out individually for separate optical elements 203 and 204 of the autoscopic multiview display and at any point in the display image plane.

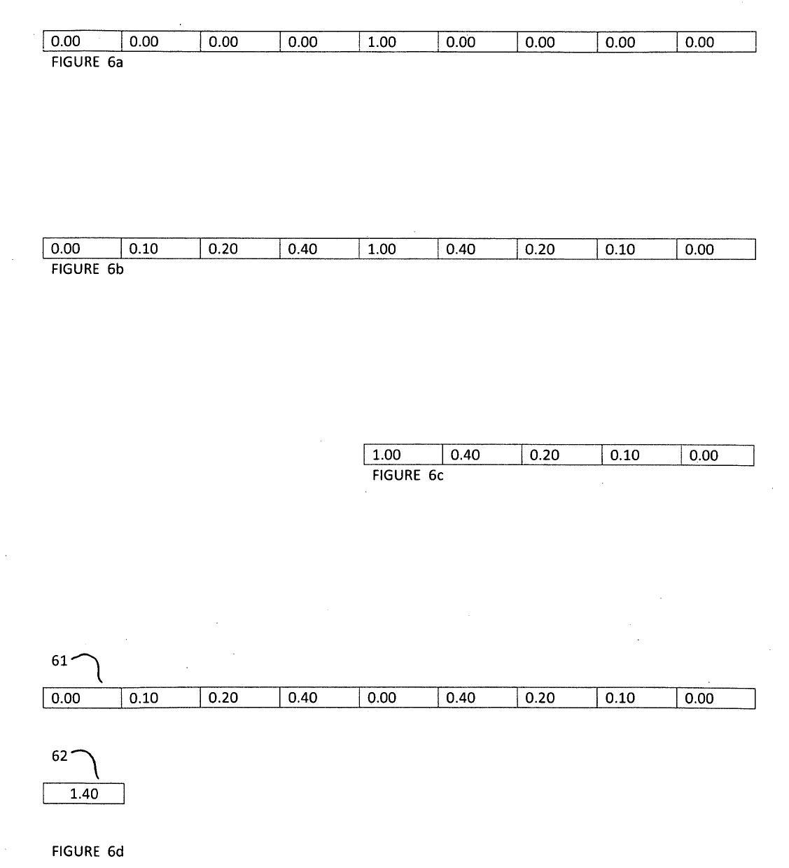

FIG. 6a shows values of the patches comprising a calibration image that would be selectively displayed by the autoscopic multiview display device under ideal circumstances, in the absence of cross talk.

FIG. 6b shows the actual values observed for the patches corresponding to those of FIG. 6a, with the perceived effects of crosstalk present;

FIG. 6c shows an abbreviated representation of the crosstalk values of FIG. 6b where the assumption of a symmetrical configuration of the crosstalk influence permits a reduction in terms for calculations. In the preferred embodiment of the present invention such symmetry is assumed to be present, however this is not a requirement in performing the present invention.

FIG. 6d shows a table 61 listing the absolute value of the difference between the ideal performance shown in FIG. 6a and the observed performance shown in FIG. 6b. A single value 62 is arrived at by accumulating through summing the values listed in the difference table 61. This value 62 is the fitness grade that quantifies the extent to which the observed display deviates from an ideal display.

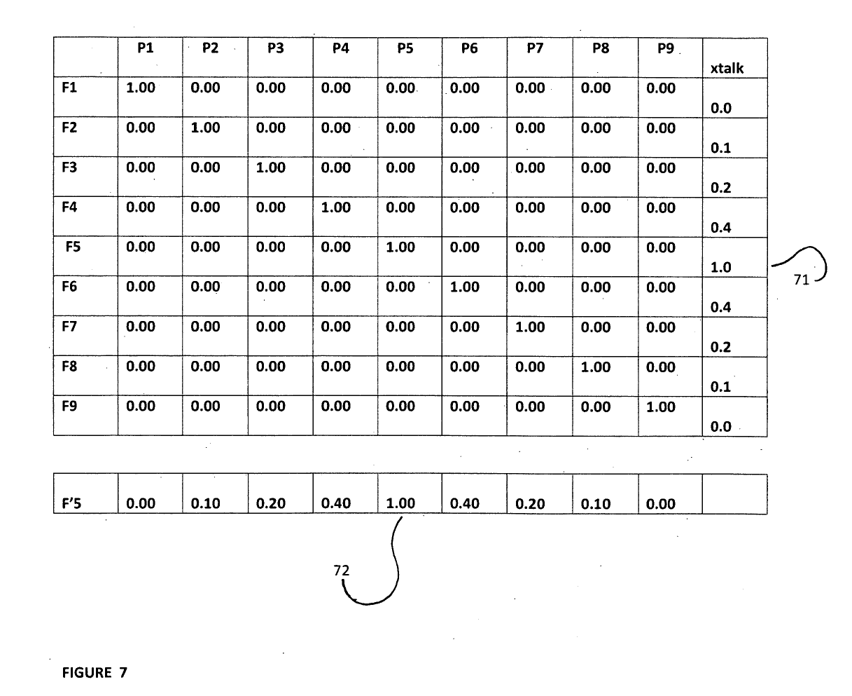

FIG. 7 shows a table of color values for a set of nine calibration images consisting of nine patches each of uniform brightness at corresponding locations in each calibration image. The values of all nine patches located on each of the nine image components in the multiview image set are shown in rows prefaced F1 through F9. Each test frame has one white patch and the rest are black, and the white patch is in a different location in each of the calibration images. The columns headed by P1 through P9 list the color value existing at a particular patch in the same location for each of the nine calibration images. The value 1.00 corresponds to a white color and the value 0.00 corresponds to a black color. The observed values listed in FIG. 6b depict the spreading and smearing effect of crosstalk, where instead of the sharp and isolated patch of a single element that is depicted by the isolated value of 1.00 in FIG. 6a there is a spread of grey imagery on either side of what would be a single white patch in the ideal case. These values that are recorded by the camera 401 are in the preferred embodiment an average of the values appearing in the region of the color patches. This averaging is performed in order to reduce the noise and other variations in both the camera and the display. The observed values recorded from a particular viewpoint and listed in the table of FIG. 6b are recorded as crosstalk coefficients and these values are entered into the table of FIG. 7 in the column headed with the symbol xtalk.

FIG. 7 shows that for image component F1 patch P1 is white and the other patches P2 through P9 are black. For image component F2 patch P1 is black, patch P2 is white and patches P3 through P9 are black. FIG. 7 includes data array prefaced F′5 which lists the values for the image patches recorded according to the operation depicted in FIG. 4 where display 404 is recorded from a particular observation position 401. A value of 1.0 is indicated at 71 which was determined by the brightness of the fifth patch 55 shown in FIG. 5. This indicates that the angle of view at which the display was observed caused the preferential selection of image element 5 from within the multiview image set. This selection by view angle is performed by the operation of the autoscopic multiview display apparatus. The values observed for the patches P1 through P9 of the display are normalized to a range from 0.0 to 1.0 and listed in the column labeled xtalk. These are the crosstalk coefficients of each of the nine constituent image elements F1 through F9 in this multiview image set.

Once the crosstalk coefficients have been established through observation of the display the appearance of the display according to that observation can be explained and predicted by scaling the values of the color components within an individual frame according to that frames crosstalk contribution and summing all of the frames together. For example in FIG. 7 each value corresponding to a patch color located in the fifth image element of the calibration set is listed in the table row prefixed with F5 each of these values is multiplied by the corresponding crosstalk coefficient 71. In each row the patch vales P1 through P9 are scales by the values in the column headed with xtalk and then the columns are summed. For the column headed by P5, since all values except the one in the fifth row are zero the total 72 listed in the fifth position of the table prefixed F′5 is the product of 1.0 and the fifth crosstalk coefficient 71.

FIG. 7 shows how the unique arrangement of the values 1.0 and 0.0 in the calibration image set that are arranged as an identity matrix with the crosstalk values in the column headed xtalk used to compute the expected imagery that will appear on the autoscopic multiview display at the fifth viewing position in the multiplexed sequence. The calibration images are designed to result in values configured reversibly with respect to the observed values seen as colors within each image and the fractional numerical crosstalk coefficients applied across the set of separate and individual images. This reversible relationship allows the interchange of color values and fractional crosstalk values, and the application of a single matrix operation to convert back and forth between them.

In FIG. 7 the crosstalk coefficients have the maximum value of 1.0 in row F5 indicated at 71 which results from viewing the display from a location that selects the fifth image in the image set as the predominate image. The values that are listed in the row prefaced by F′5 are computed by multiplying each value within a row by its corresponding crosstalk coefficient that is displayed in the rightmost column and then summing the values in each column. In the case of the calibration set of images shown in FIGS. 3a through 3i the matrix of FIG. 7 operates as an identity transform with the crosstalk values and the colors of the patches within each image having values that directly correspond.

The appearance of the observed display can be predicted for multiview image sets differing from the image set with which the calibration has been performed. In the case of image sets comprised of spatially coincident patches similar to the calibration images the observed results for color patches that will be seen on the display can be predicted even when the colors of the patches in the supplied image set are changed.

Because the changed colors still occupy just one value in the matrix, efficient computations can be performed using only the matrix of values P1 though P9 by F1 through F9. The value representing the image brightness for any patch in any image can be substituted with another value and the operation of scaling according to the crosstalk coefficients and then summing the frames as previously described will predict the observed values under these new conditions. In this way the effects of the real world autoscopic multiview display can be efficiently predicted for a large number of source image sets.

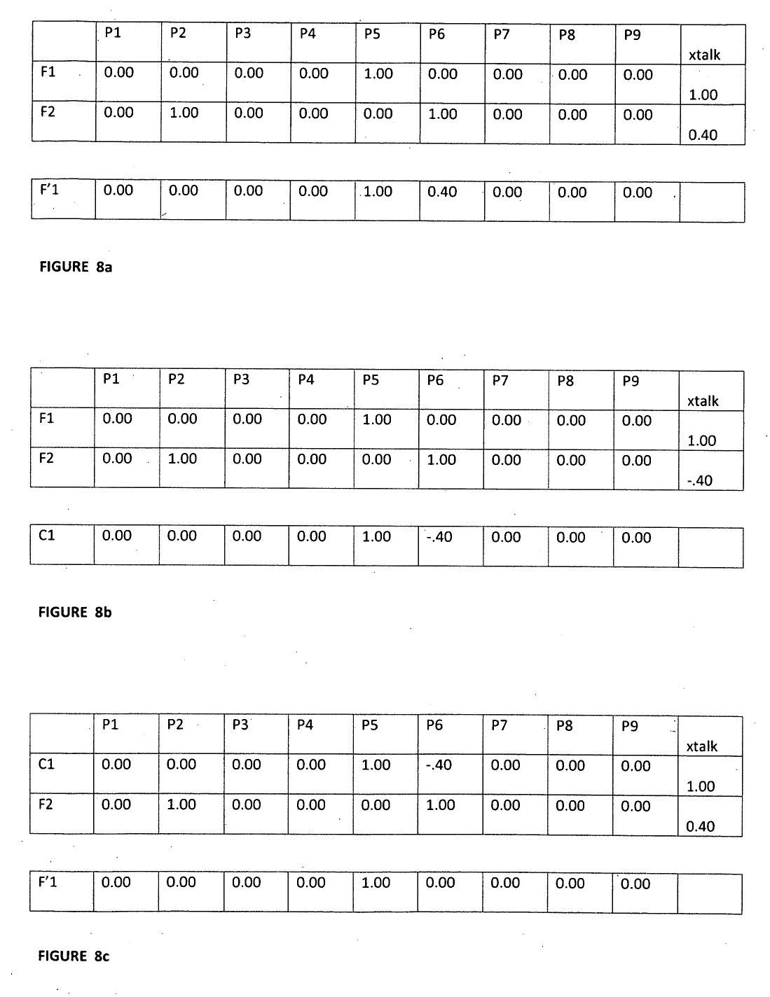

FIGS. 8a, 8b, 8c present prior art pertaining to the cancelation of crosstalk occurring in pairs of stereo images. In FIG. 8a there is shown the values of color patches for just two images instead of the set of three or more used in the present invention. The color configuration of the patches in a left eye image is shown with prefix F1 and the color configuration of the patches in a right eye image are shown with prefix F2. In the case of crosstalk ghosting from F2 into F1 with a leakage factor of 0.4 an operation of multiplying and summing on just these two images can be performed as above resulting in the values prefixed with F′1 that show how the image with crosstalk will appear to the left eye. According to procedures familiar to one skilled in the art of stereoscopic artifact cancellation the crosstalk coefficient is inverted and a correcting image is made with the values prefixed by C1. When C1 is substituted for F1 and viewed on a stereoscopic display having a crosstalk leakage of 0.4 the simulation indicated in FIG. 8c shows that the frame viewed by the left eye will have the values listed in the table prefixed by F′1 and that the crosstalk will have been eliminated.

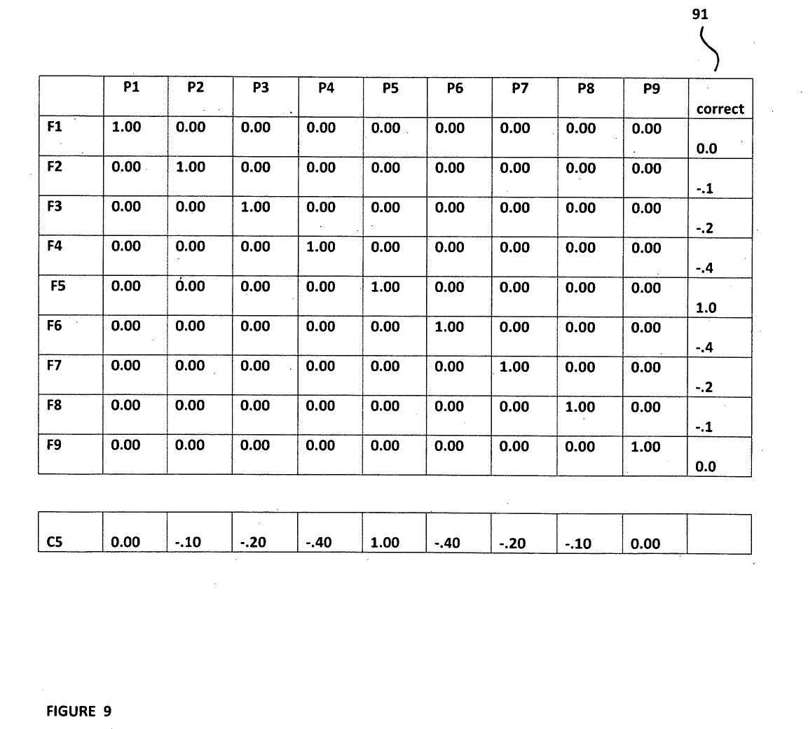

This commonly understood method will not work in the case of a multiframe autoscopic display with three or more image components. FIG. 9 shows how the prior art for the two image components in a stereoscopic display could be obviously extended to more frames and in this case nine frames. The crosstalk coefficients in the column headed correct are inverted from the observed values for the unwanted image frames and set to 1.0 for the frame to be isolated from the effects of interframe crosstalk. The scaling and summing is performed as with the aforementioned view position simulation resulting in a correcting image whose values are listed in the table prefixed with C5. In practice, the negative values and values exceeding one would be accommodated by effectively scaling and clipping the gamut of the display device to locate the range of 1.0 to 0.0 within the usable gamut leaving sufficient room in the extremes as well as by other known methods.

The computations used to create the correcting frame C5 shown in FIG. 9 can in a likewise manner be computed for the other viewing positions of the autoscopic multiview display favoring the other components of the multiview image set.

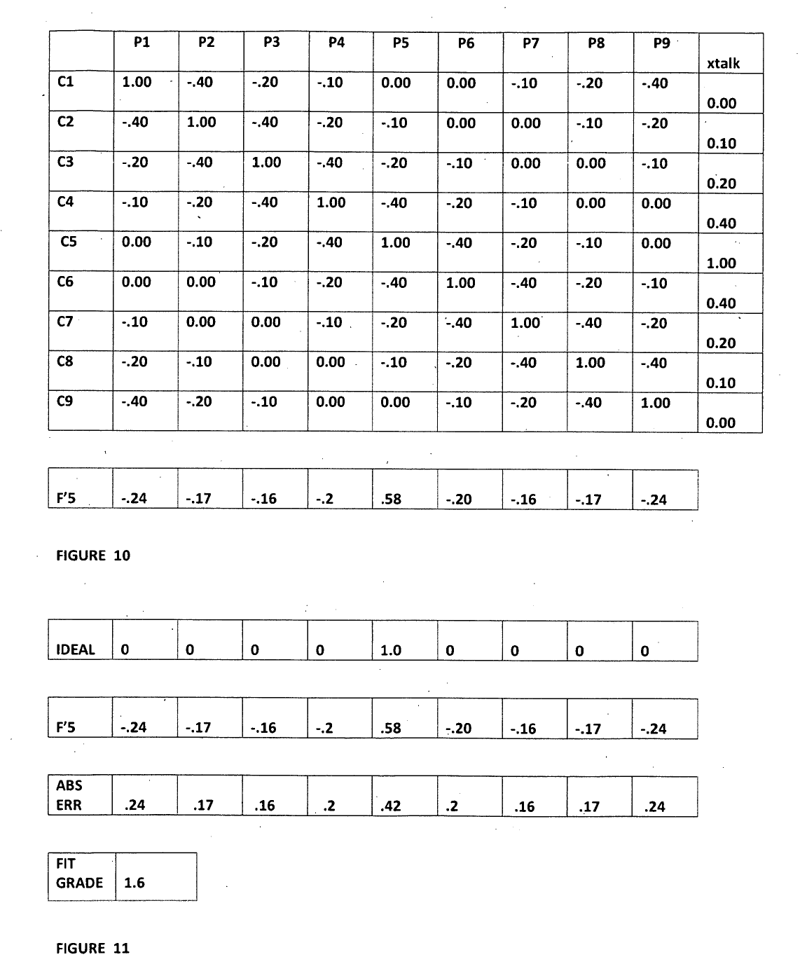

FIG. 10 shows these nine correcting frames with values listed in the tables prefixed with C1 through C9. This data matrix is operated using the observed crosstalk coefficients to simulate a view of the multiframe autoscopic display. The results are listed in the table prefixed with F′5.

FIG. 11 shows the data for the ideal result and the simulated result that are used to calculate the absolute value of the differences that are listed in the table prefixed with ABS ERR. These values are summed to determine the fitness grade which is 1.6 in this example. This represents a poor performance of the crosstalk cancellation operation as performed because the multiview image set comprised of the correcting images lacks the adaptive crosstalk cancellation information of the present invention.

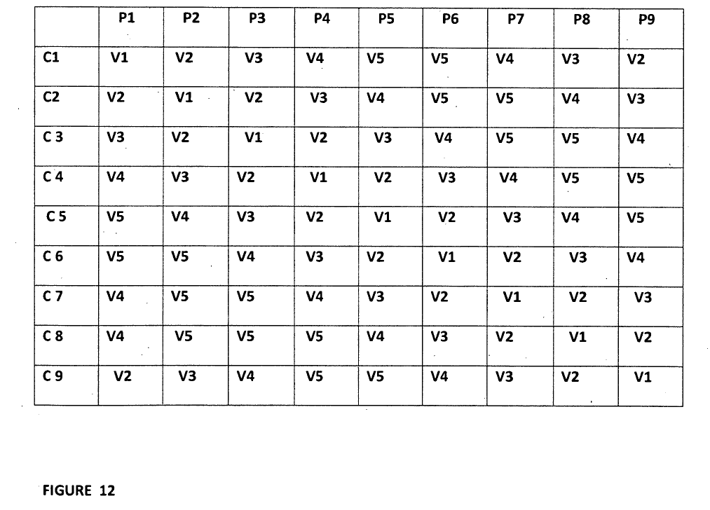

FIG. 12 shows the arrangement of the five variables V1 through V5 that are color values for patches in component frames prefixed with C1 through C9. They are arranged symmetrically in each row around the color values assigned as white in the image calibration set illustrated in FIGS. 3a through 3i. The value V1 in FIG. 12 is located where the white patches are indicated in FIG. 7 by the numerical value 1.00 appearing in the diagonal positions of the display simulation matrix. The variable V2 appears on either side of V1 in each row because the appearance of ghosting is assumed to be symmetrical in the calibration configuration with the ghosting leakage of the preceding frame in the image set being the same as the ghosting leakage of the following frame in the image set due to the practice of adjusting the point of observation to maximize the brightness of a single color patch seen on the multiframe autoscopic display when recording the crosstalk coefficients.

In FIG. 9 the values shown in column 91 headed by the word CORRECT are used as correction coefficients. An object of the determination of the adaptive crosstalk cancellation information is to identify the values for this column of the matrix that produce a correcting image for each member of the multiview display image set that embodies the interrelation and the concatenations that occur as corrections are made to further include other corrections to the total product of the autoscopic multiview display, that taken together have a complex relationship that constitutes adaptive crosstalk cancellation information. Adaptive crosstalk cancellation information is introduced for the first time in the present invention. When adaptive crosstalk cancellation information is present in a multiview image set all the concerted manifestations of crosstalk and ghosting occurring in a multiframe autoscopic display will be countered to the maximum degree.

The sparse computation required to operate on the matrix described in FIG. 7 allows an exhaustive permutation of display simulations to be performed. Any simulation that is performed can also be efficiently graded relative to the display performance that would be achieved by an ideal autoscopic multiview display as described by FIG. 2A. As a result of the uniquely simplifying process of creating calibration images with color values as described above and arranging those values in a matrix configuration with the crosstalk coefficients, the arrangement of variables V1 through V5 at the positions shown in FIG. 12 accounts for all the permutations of crosstalk coefficients whose action is accumulated by the multiframe autoscopic display. It is a property of multiframe autoscopic displays that the crosstalk interference contributed at image 1 in the multiview image set by image 2 in the same set will be greater than the crosstalk contributed to image 1 by image 3 in the same image set. For each component frame the leakage from other image components is directly proportional to the proximity of those images in the multiview image set.

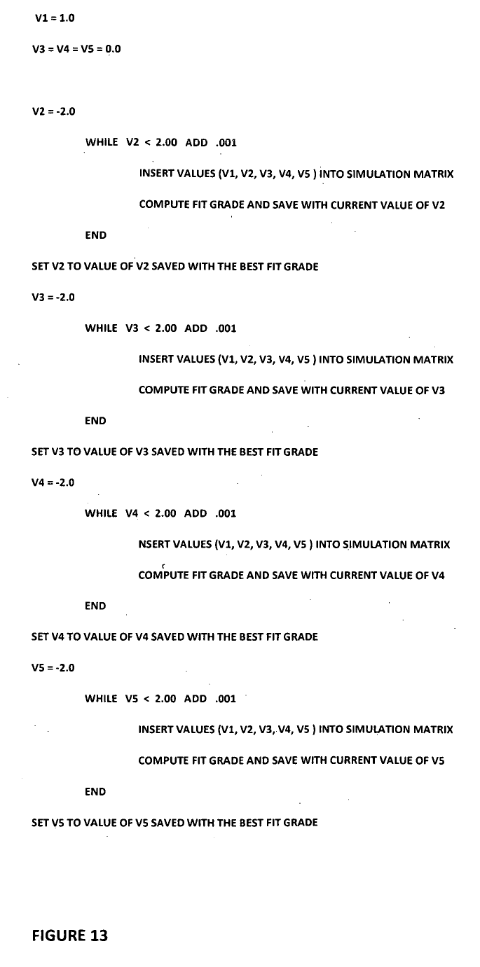

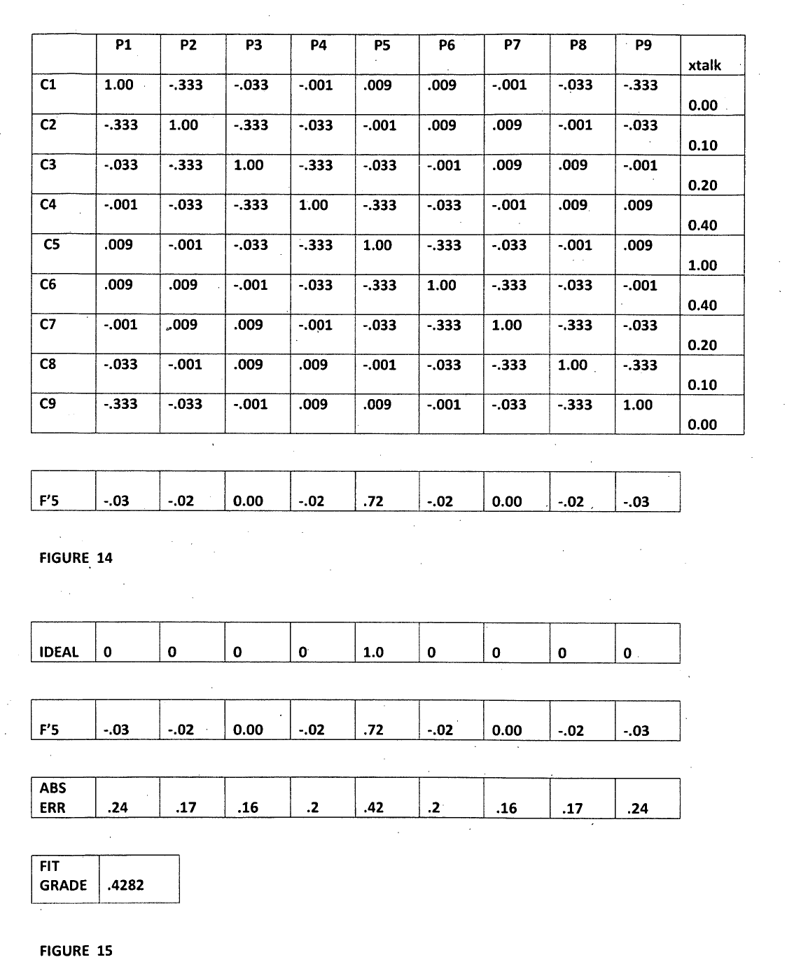

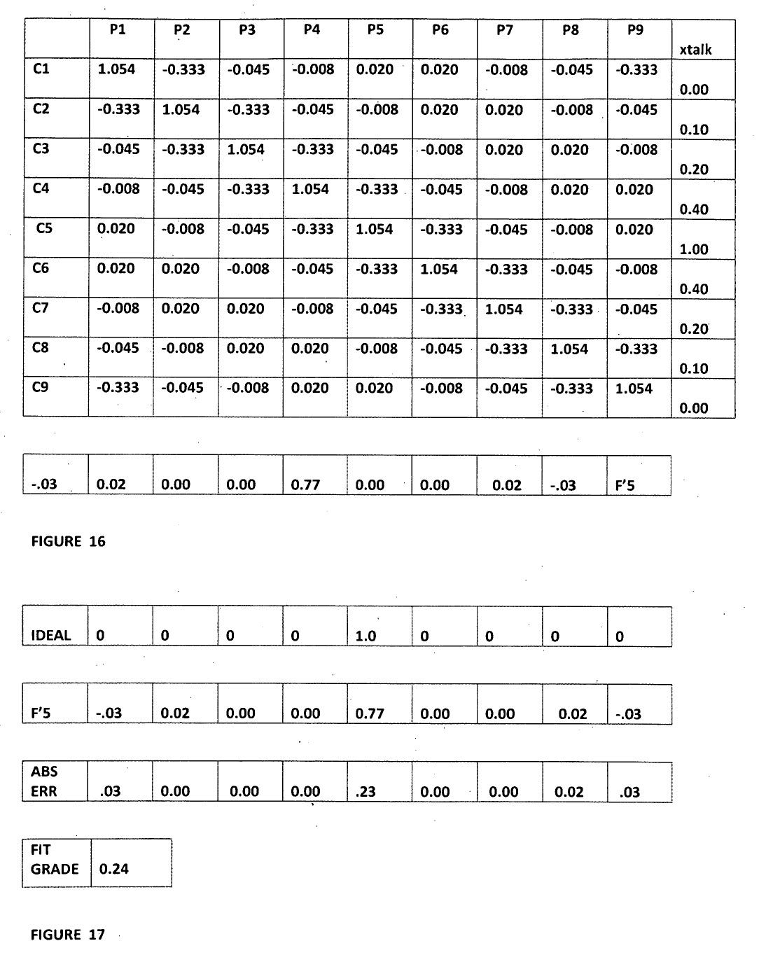

This relationship is used to prioritize an automatic search for the adaptive crosstalk cancellation information as shown in the pseudocode algorithm shown in FIG. 13. The values of V1 through V5 are each permuted through their entire range while the cumulative fitness grade is determined for each configuration of the values in the simulation matrix. One pass of adapting the crosstalk cancellation values proceeds by setting V1 to 1.0 and testing all possible values for V2 according to a predetermined granularity of 0.001 and selecting the value of V2 associated with the smallest deviation from the ideal in a simulation of the multiview image set having colored patches valued according the configuration shown in FIG. 12. That value for V2 achieving the best fitness grade is retained and the process is repeated likewise testing and grading all values for V3. One pass of the adapting of the crosstalk cancellation information is completed when V4 and V5 have been set in a similar manner.

The second pass of adapting the crosstalk cancellation information begins with permuting V1 and grading the simulation results while retaining the values of the other variables from the previous pass. Additional passes are performed by sequencing this procedure permuting V1 through V5 and grading the resulting fitness. As additional passes are performed the values of V1 through V5 and the value of the fitness grade are seen to converge on an optimum value. When this convergence is within a predetermined increment and the improvement in the fitness grade no longer improves on subsequent passes or improves by a negligible amount then the adaptive crosstalk cancellation information is present.

The values arrived at for V1 through V5 are then arranged in a calculation matrix as shown in FIG. 9 where the illustration shows values in column 91 and shown as follows:
0.0, −0.1, −0.2, −0.4, 1.0, −0.4, −0.2, −0.1, 0.0

These are replaced with the values of V1 through V5 in the following order:
V5, V4, V3, V2, V1, V2, V3, V4, V5

The simulation operation is then performed not on the single values representing the color of the patches in calibration multiview image set, but on the entire image content for each image in a multiview image set in preparation for viewing by an autoscopic multiview display. The process of scaling and summing performed on the single values in the simulation matrix is now performed on images in a manner that is familiar to those skilled in the art of arithmetical operations on image data. Each constituent image in the multiview image set has the other images of the set proportionally and fractionally combined with it according to the values V1 through V5. The multiview image sets treated in this manner will demonstrate adaptive crosstalk cancellation information by exhibiting optimum elimination of ghosting effects when viewed by an autoscopic multiview display as compared to the same multiview image sets not treated in this manner.

Adaptive crosstalk cancellation information does not need to be produced by the iterative method described here, or by any particular method, it is rather a unique, novel, and valuable property of the corrected image sets themselves previously unknown and created for the first time by this invention. A variety of mathematical procedures and operations can be performed on the multiview image set data with same result of achieving the informational relationship introduced by this invention. This relationship that is made apparent by the present invention is distinct from the prior art in the property of having the minimum possible cumulative error in multiview image sets with three or more members.

The scope of the invention should be determined by the appended claims and their legal equivalents, rather than by the examples given.

I claim:

1) Pictorial data containing adaptive crosstalk cancelation information and stored on electronically readable media for transfer to an autoscopic display apparatus wherein component frame elements of said pictorial data interact to suppress or eliminate artifacts produced by said autoscopic display apparatus, composed of: pictorial data stored on electronically readable media having a serial set of more than two frames, at least one current frame component of said serial set incorporating arithmetically processed image data, where said arithmetically processed image data is comprised of image data from at least a prior and a next frame in the serial set each having been scaled by a respective adaptive crosstalk coefficient, where said adaptive crosstalk coefficient for at least a prior and a next frame respectively has a relation to the predetermined magnitude of interframe crosstalk contributed by the images comprising a multiview image set presented by an autoscopic multiview display when viewed from the current frame's preferred viewing position, where said relation includes adaptive crosstalk cancelation information.

2) The pictorial data of claim 1 where the arithmetically processed image data is comprised of image data from frames adjacent to the current frame including a prior and a next frame in addition to frames at further removed positions in the serial set where the relation of the magnitude of the inverse artifact coefficient is controlled by adaptive crosstalk cancelation information.

3) The pictorial data of claim 1 and claim 2 in which the autoscopic display apparatus is a lenticular display.

4) The pictorial data of claim 1 and claim 2 in which the autoscopic display apparatus is a barrier strip display.

5) The pictorial data of claim 1 and claim 2 in which the autoscopic display apparatus is a holographic display.

6) Pictorial data containing adaptive crosstalk cancelation information and stored on hardcopy media for display by an autoscopic display apparatus wherein component frame elements of said pictorial data interact to suppress or eliminate artifacts produced by said autoscopic display apparatus, composed of: pictorial data present in hardcopy media having a serial set of more than two frames, at least one current frame component of said serial set incorporating arithmetically processed image data, where said arithmetically processed image data is comprised of image data from at least a prior and a next frame in the serial set each having been scaled by a respective adaptive crosstalk coefficient, where said adaptive crosstalk coefficient for at least a prior and a next frame respectively has a relation to the predetermined magnitude of interframe crosstalk contributed by the images comprising a multiview image set presented by an autoscopic multiview display when viewed from the current frame's preferred viewing position, where said relation includes adaptive crosstalk cancelation information.

7) The pictorial data of claim 6 where the arithmetically processed image data is comprised of image data from frames adjacent to the current frame including a prior and a next frame in addition to frames at further removed positions in the serial set where the relation of the magnitude of the inverse artifact coefficient is controlled by adaptive crosstalk cancelation information.

8) The pictorial data of claim 6 and claim 7 in which the autoscopic display apparatus is a lenticular display.

9) The pictorial data of claim 6 and claim 7 in which the autoscopic display apparatus is a barrier strip display.

10) The pictorial data of claim 6 and claim 7 in which the autoscopic display apparatus is a holographic display.

11) The pictorial data of claim 1 and claim 2 and claim 6 and claim 7 in which adaptive crosstalk cancelation information is created according to stored data representing the crosstalk conditions created by an autoscopic multiview display and associated with the autoscopic multiview display as a display profile.

12) The pictorial data of claim 1 and claim 2 and claim 6 and claim 7 in which adaptive crosstalk cancelation information is applied to a multiview image set at a remote location and the image set containing adaptive crosstalk cancelation information is delivered to the proximate autoscopic multiview display.

13) The pictorial data of claim 1 and claim 2 and claim 6 and claim 7 in which adaptive crosstalk cancelation information is applied to a multiview image set at a proximate location and the image set containing adaptive crosstalk cancelation information is presented by the proximate autoscopic multiview display.

14) The pictorial data of claim 13 where data describing the interframe crosstalk performance of the autoscopic multiview display is stored at a remote location prior to delivery to a proximate location and the corresponding adaptive crosstalk cancelation information is applied to an image set prior to presentation by the proximate autoscopic Multiview display.
